(19) United States
(12) Patent Application Publication
(10) Pub. No.: US 2020/0380482 A1
(43) Pub. Date: Dec. 3, 2020

(54) METHOD AND SYSTEM FOR IMPLEMENTING AN ELECTRONIC EXCHANGE FOR BILL PAY AND OTHER TRANSACTIONS VIA AN INTERBANK INFORMATION NETWORK (IIN)

(71) Applicant: JPMorgan Chase Bank, N.A., New York, NY (US)

(72) Inventors: Stephen HOFFMAN, Batavia, IL (US); Sejdo Radoncic, Bronx, NY (US); Tiffany Ashley Wan, New York, NY (US); Amy M. Leslie, Ann Arbor, MI (US); John L. Biloz, Wonder Lake, IL (US); Raghvendra Singh, Brooklyn, NY (US)

(21) Appl. No.: 16/887,031

(22) Filed: May 29, 2020

Related U.S. Application Data
(60) Provisional application No. 62/854,567, filed on May 30, 2019.

(51) Int. Cl. G06Q 20/10; G06Q 20/36; G06Q 20/02; H04L 9/32

(52) U.S. Cl. CPC G06Q 20/102; G06Q 20/3676; G06Q 20/023; H04L 2209/38; G06Q 2220/12; H04L 2209/56; H04L 9/3236

(57) ABSTRACT

The invention relates to an electronic exchange for bill pay transactions via an interbank information network (IIN) architecture. An embodiment of the present invention provides a marketplace for secure collection, assignment and distribution of payments and data from Bill Pay to Lockbox providers. This eliminates paper checks, resulting in faster deposit into client accounts, better management of payment exceptions, and reduction in overall operating costs. The IIN architecture provides a global platform using Blockchain technology for real-time interconnected flow of information that address immediate pain points across the financial industry and enable new services. With an embodiment of the present invention, a distributed network may streamline process for resolving compliance based inquiries and provide global beneficiary account validations. An embodiment of the present invention provides a platform/ecosystem that network participants may use to deliver value-added service applications to other network participants.

### CROSS REFERENCE TO RELATED APPLICATIONS

The application claims priority to U.S. Provisional Application 62/854,567 (Attorney Docket No. 72167.001697), filed May 30, 2019, the contents of which are incorporated herein in its entirety.

### FIELD OF THE INVENTION

The invention relates generally to a method and system for implementing an electronic exchange via an Interbank Information Network (IIN) for bill pay transactions destined for paper lockboxes and other checks originated from large check origination providers.

### BACKGROUND OF THE INVENTION

Each year, tens of millions of bill pay transactions start out as a digital payment transaction, but turn into a check that is mailed from a bank and commercial bill payers out to billers. These billers receive their checks via an in-house lockbox or one operated by Banks or third party providers. Bill Pay providers send millions of physical checks each year to Lockboxes across the industry. This transaction costs the billers and the industry 10 times more than if the payment were routed electronically. In addition, this process generates a delay in deposit into client accounts and additional operational costs for both Bill Pay and Lockbox Providers (e.g., postage fees, sorting and processing of paper checks, etc.). Because there are several root causes to why a bill pay transaction turns into a check, this problem is not going away anytime soon. Current solutions require clients to adopt and make changes to their back office systems. However, these solutions involve extensive time and resources for industry participants.

These and other drawbacks currently exist.

### SUMMARY OF THE INVENTION

According to one embodiment, the invention relates to a system for implementing an electronic exchange via an interbank information network (IIN) architecture for bill pay transactions. The system comprises: a first electronic input in communication with a bill pay platform associated with one or more bill payors; a second electronic input in communication with a lockbox platform associated with one or more lockbox service providers; and a computer processor, coupled to the first electronic input and the second electronic input, the computer processor executing an Interbank Information Network (IIN) application and is further configured to perform the steps of: receiving, via the first electronic input, data elements from the bill pay platform; receiving, via the second electronic input, reference data elements from the lockbox platform; comparing, via the computer processor, the data elements and the reference data elements to identify one or more participants; identifying, via the computer processor, a first set of transactions that require a check print and a second set of transactions that require processing through an Interbank Information Network (IIN); transmitting, via the computer processor, a corresponding payment file for the second set of transactions to a centralized lockbox deposit account; and transmitting, via the computer processor, a lockbox file to the one or more participants via the lockbox platform.

According to another embodiment, the invention relates to a method for implementing an electronic exchange via an interbank information network (IIN) architecture for bill pay transactions. The method comprises the steps of: receiving, via a first electronic input, data elements from a bill pay platform, wherein the first electronic input is in communication with the bill pay platform associated with one or more bill payors; receiving, via a second electronic input, reference data elements from a lockbox platform, wherein the second electronic input is in communication with the lockbox platform associated with one or more lockbox service providers; comparing, via a computer processor, the data elements and the reference data elements to identify one or more participants, wherein the computer processor is coupled to the first electronic input and the second electronic input and executes an Interbank Information Network (IIN) application; identifying, via the computer processor, a first set of transactions that require a check print and a second set of transactions that require processing through an Interbank Information Network (IIN); transmitting, via the computer processor, a corresponding payment file for the second set of transactions to a centralized lockbox deposit account; and transmitting, via the computer processor, a lockbox file to the one or more participants via the lockbox platform.

A method of an embodiment of the present invention may be conducted on a specially programmed computer system comprising one or more computer processors, mobile devices, electronic storage devices, and networks.

The computer implemented system, method and medium described herein can provide the advantages of improved bill pay processing. The various embodiments of the present invention achieve benefits and advantages for customers as well as financial institutions and lockbox operators. An embodiment of the present invention is directed to leveraging an Interbank Information Network (IIN) to transform lockbox operations into digital transactions. As a result, bill pay checks that are currently being printed, mailed, received, opened, extracted, data captured and reconciled manually would be eliminated or substantially minimized. The digital bill pay lockbox platform of an embodiment of the present invention improves timeliness of clients getting paid for services and significantly decreases costs of paper, postage and processing time. In addition, billers, namely lockbox clients, do not have to change their systems or sign up for a lockbox processing service. Moreover, the digital bill pay lockbox platform does not require end user clients to sign up for or opt in to a cost reducing offering. The digital bill pay lockbox platform further improves quality, avoids manual mistakes and improves rates of reconciliation.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flow illustrating an electronic exchange for bill pay transactions, according to an embodiment of the present invention.

FIG. 2 is an exemplary flow illustrating an electronic exchange for bill pay transactions via IIN, according to an embodiment of the present invention.

FIG. 3 is an exemplary flow illustrating an electronic exchange for bill pay transactions via IIN, according to an embodiment of the present invention.

FIG. 4 is an exemplary flow illustrating an electronic exchange for bill pay transactions via IIN, according to an embodiment of the present invention.

FIG. 5 is an exemplary system diagram, according to an embodiment of the present invention.

FIG. 6 is an exemplary system diagram, according to an embodiment of the present invention.

FIG. 7 is an exemplary system diagram, according to an embodiment of the present invention.

FIG. 8 is an exemplary system diagram, according to an embodiment of the present invention.

FIG. 9 is an exemplary flow illustrating an electronic exchange for bill pay transactions via IIN, according to an embodiment of the present invention.

FIG. 10 is an exemplary flow illustrating an electronic exchange for bill pay transactions via IIN, according to an embodiment of the present invention.

FIG. 11 is an exemplary flow illustrating a settlement flow, according to an embodiment of the present invention.

FIG. 12 is an exemplary flow illustrating a settlement flow, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention provides a marketplace for secure collection, assignment and distribution of payments and data from Bill Pay to Lockbox providers. This eliminates paper checks, resulting in faster deposit into client accounts, better management of payment exceptions, and reduction in overall operating costs. For example, a consumer may receive a bill from a biller. The consumer may log onto a Bill Pay portal and submit a payment. An Interbank Information Network (T N) application may collect, align, and distribute Bill Pay payments and data to lockbox operations. Lockbox operations may receive digital payments, data and addendum and then distribute to a client. The client may then receive data and payments.

An embodiment of the present invention is directed to creating a digital exchange of data among industry providers for bill pay and lockbox transactions via Interbank Information Network (IIN). Details concerning the Interbank Information Network (IIN) are provided in U.S. application Ser. No. 16/279,137 (Attorney Docket No. 72167.001633), filed Feb. 19, 2019, which is a continuation of U.S. application Ser. No. 16/015,709 (Attorney Docket No. 72167.001459), filed Jun. 22, 2018, which claims priority to U.S. Provisional Application 62/523,429 (Attorney Docket No. 72167.001239), filed Jun. 22, 2017, the contents of which are incorporated herein in their entirety. The application also relates to U.S. application Ser. No. 16/788,396 (Attorney Docket No. 72167.001834), filed Feb. 12, 2020, which claims priority to U.S. Provisional Application 62/804,429 (Attorney Docket No. 72167.001643), filed Feb. 12, 2019, the contents of which are incorporated herein in its entirety. An embodiment of the present invention is directed to creating an electronic exchange process so that lockbox clients' experience is not changed, with minimal to no intervention from these clients. According to an exemplary scenario, a financial institution may provide and maintain the electronic exchange. For example, a financial institution or other entity may commercialize participation in the exchange and fund it via maintenance fees as well as discounted transaction fees.

According to an embodiment of the present invention, the IIN provides a global platform using Blockchain technology for real-time interconnected flow of information that addresses immediate pain points across the financial industry and enables new services. For example, the IIN as the distributed network may streamline the process for resolving compliance based inquiries and provide global beneficiary account validations. The IIN of an embodiment of the present invention may be directed to a platform/ecosystem that network participants may use to deliver value-added service applications to other network participants.

The IIN's live in production infrastructure and operating model support Bill Pay and Lockbox at participant banks and entities. Participants have the flexibility to use various applications. For example, IIN participants may choose how to use Bill Pay and Lockbox features. IIN may support a variety of information share applications as a platform. For example, IIN may incorporate money movement on ledger as part of the Bill Pay and Lockbox solution.

An embodiment of the present invention provides an ability to market to commercial providers who are not considered major players in the industry and also to corporate clients who process their own checks in-house. According to an embodiment of the present invention, Blockchain and/or other distributed ledger technology and implementation of Blockchain may be applied to improve security so that the system may be less reliant on current payment processing rails.

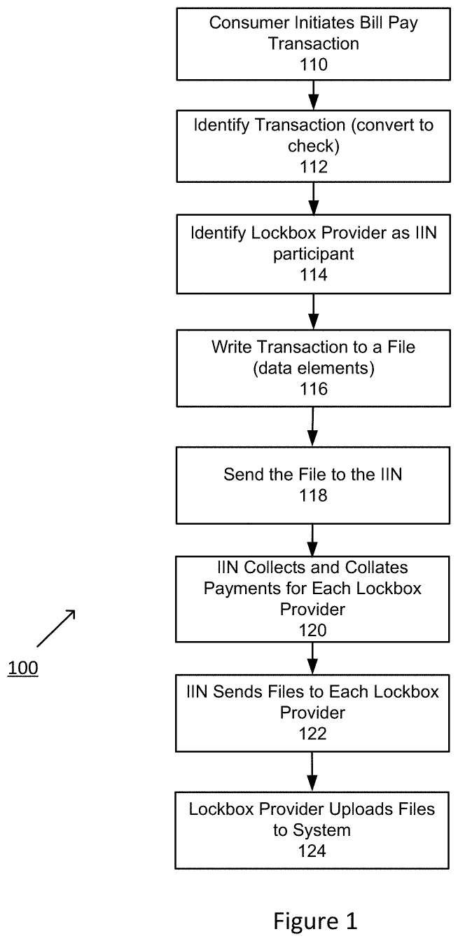

FIG. 1 is an exemplary flow illustrating an electronic exchange for bill pay transactions via IIN, according to an embodiment of the present invention. At step 110, a customer initiates a bill pay transaction. At step 112, the transaction may be identified as one that is to be converted to a check. This may be done by the bill payer. At step 114, the payment may be identified as being destined for a lockbox provider participating in an IIN. At step 116, the transaction may be written to a file with a set of data elements. At step 118, the file may be sent to the IIN from the bill payer provider. At step 120, the IIN may then collect and collate the payments destined for each lockbox provider participant. This may include a bank, a third party and/or corporate lockbox participants. At step 122, the IIN may send daily (or other periodic) files to each lockbox provider. This may include options on how the financial transaction is processed. For example, options may include a one lump sum daily total payment accompanied by the data file that breaks down the distribution of funds, check images to be processed as ICLs (image cash letters), or converted to Automated Clearing House (ACH). ACH represents an electronic network for financial transactions. The ACH network facilitates electronic money transfers and automatic payments between banks and financial institutions. Other types of payment may be supported. At step 124, the data files and the payment files may be received and uploaded into each lockbox provider's systems. The order illustrated in FIG. 1 is merely exemplary. While the process of FIG. 1 illustrates certain steps performed in a particular order, it should be understood that the embodiments of the present invention may be practiced by adding one or more steps to the processes, omitting steps within the processes and/or altering the order in which one or more steps are performed.

Bill Pay providers send paper checks to physical Lockbox providers across the industry. This process generates operational cost for both sides of the payment transactions (e.g., postage fees, sorting and processing of paper checks, etc.). Internally, a financial institution may send paper checks to a lockbox for specific reasons, including inability to process e-payment for e-Lockbox clients due to incorrect payment information. In addition, paper checks may be needed for lockbox clients that are not subscribed to an electronic service, such as e-Lockbox or Automated Clearing House (ACH) Direct Send.

An embodiment of the present invention is directed to providing a centralized network to enable banking participants (e.g., bill payers and lockbox providers) to compress, net and process payments. Banking participants may also generate related data files and provide exception management capabilities. With the various features of an embodiment of the present invention, the system may eliminate (or substantially reduce) physical check exchange between bill pay providers and lockbox providers leading to increased cycle time for processing electronic payments. Additional benefits may include reduction in paper, resource savings, client benefits (e.g., faster deposits to clients' accounts and lower fees), standard industry operating model (e.g., streamline payables and receivables processes with industry participants) and improved exception management (e.g., improved handling of exceptions via auto-matching reduces impact of errors across the industry).

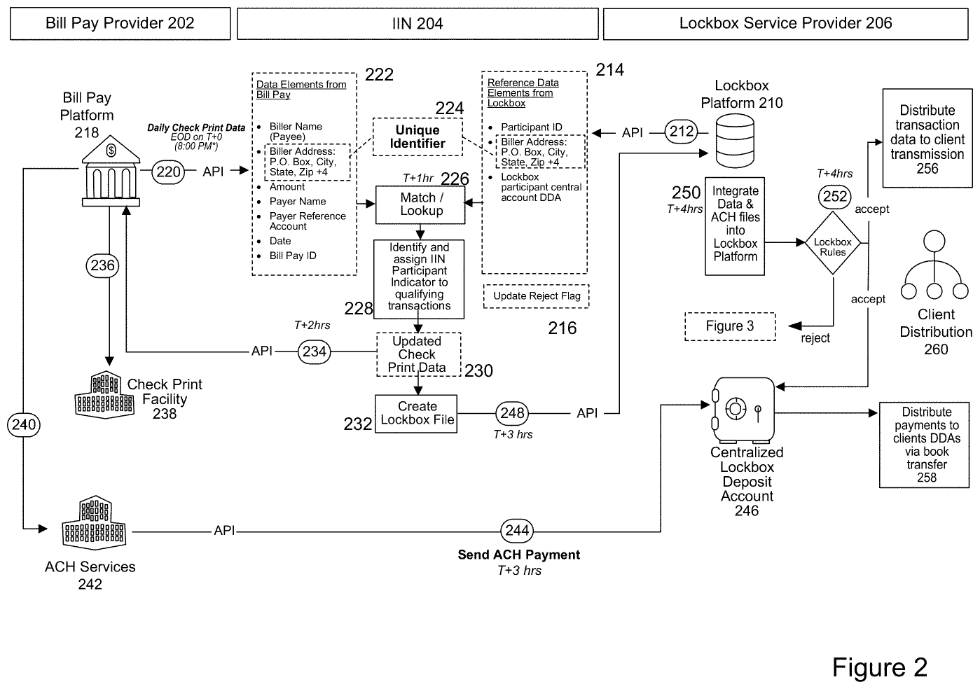

FIG. 2 is an exemplary flow illustrating an electronic exchange for bill pay transactions via IIN, according to an embodiment of the present invention. FIG. 2 illustrates a digital bill pay lockbox platform via IIN. FIG. 2 demonstrates interactions between Bill Pay Provider 202, IIN 204 and Lockbox Service Provider 206.

According to an embodiment of the present invention, a bill pay provider may initiate an electronic payment. Bill pay clients may include individuals and small businesses as well as other entities. Bill Pay Providers may include banks, financial institutions, corporate bill pay providers. Electronic payment details may include routing number, account number, biller name, an amount, date, payor account number, payer name, bill address and/or other payment data. A single data file per bill pay provider with sender details may be received by IIN. IIN may include a computer system or processor that executes an IIN application or other program.

The IIN may process the inputs. This may involve consolidating payments from bill pay providers and collating payments for lockbox providers and/or corporates. The IIN may further create a data file with determined transactions for lockbox providers and/or corporates. The IIN may create a payment file per lockbox provider and/or corporate preference. In addition, the IIN may create an image file of check templates for lockbox providers and/or corporates. The IIN may output Image Files, Data Files, Payment Files and/or other files to Lockbox Providers. Lockbox Providers may then disburse data, image and/or payments to clients and/or billers. In addition, Lockbox Providers may load data to a corresponding Accounts Receivable System. Lockbox clients may manage accounts receivable, image archive and demand deposit account (DDA) information.

As shown in FIG. 2, Lockbox Platform 210 may transmit biller data. For example, Lockbox Platform 210 may provide biller lockbox address and reference data via real time updates. Lockbox Platform may provide this information at 212 via API. Reference data elements may be represented at 214, which may include participant identifier, biller address, lockbox participant central account DDA, etc. Reference data may also include an Update Reject Flag shown by 216. Other flags may be applied to identify other conditions, status, etc.

Bill Pay Platform 218 may transmit check print files. For example, Bill Pay Platform 218 may provide daily (or other interval) check print data at 220 via an API. Data Elements 222 may include biller name (e.g., payee), biller address, amount, payer name, payer reference account, date, bill pay identifier, etc.

IIN 204 may support nodes or other interfaces to receive data. This may include Bill Pay Provider Nodes, Lockbox Provider Nodes, etc. IIN 204 may generate a unique identifier 224, which may be based on biller address information, for example. IIN 204 may match datasets from Bill Pay Provider 202 and Lockbox Service Provider 206 to identify IIN participants. At 226, IIN 204 may perform a match or lookup that compares Data Elements 222 and Reference Data 214. IIN 204 may then identify and assign an IIN participant indicator to qualifying transactions at 228. At 230, check print data may be updated. At 232, a lockbox file may be created. IIN may send an updated file with flags that identify which transactions require check print and which transaction go through IIN at 234. IIN may distribute data to Bill Pay Provider 202 and Lockbox Service Provider 206. For example, data may be published on a Distributed Ledger where access to data may be restricted and/or protected.

At 236, Bill Pay Platform 218 may send non-IIN transactions to Check Print Facility 238. At 240, Bill Pay Platform 218 may send IIN participants to ACH Services 242. At 244, ACH payment may be sent from ACH Services 242 to Centralized Lockbox Deposit Account 246. For example, ACH Services 242 may create nightly (or other interval) ACH files to each Lockbox Provider corresponding to the IIN flagged transactions. Simultaneously (or near simultaneously) with 244, IIN participant lockbox data file may be sent to Lockbox Platform 210 via 248.

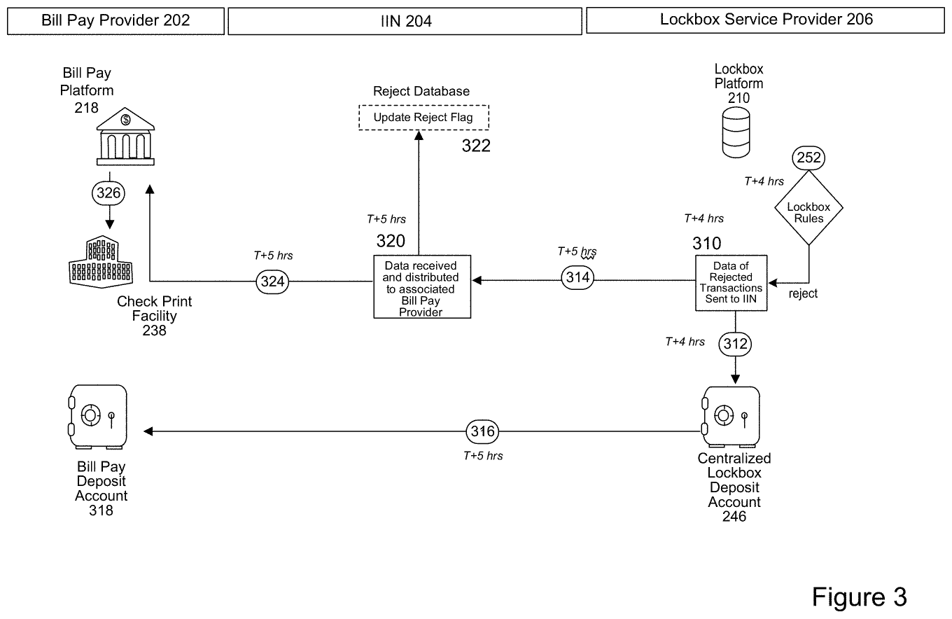

At 250, data and ACH files may be integrated into Lockbox Platform 210. At 252, lockbox rules may be applied to determine whether transactions are accepted or rejected. Other rules and/or conditions may be applied. If accepted, transaction data may be distributed to client transmission, at 256. Payments may be distributed to clients DDAs (or other accounts) via book transfer, at 258. Client distributions may be made at 260. If rejected, the flow may proceed to FIG. 3.

An embodiment of the present invention is directed to ACH files as one illustrative example. Other forms of payment may be applied. For example, an embodiment of the present invention may be applied to digital currency and other forms of payment.

FIG. 3 is an exemplary flow illustrating an electronic exchange for bill pay transactions via IIN, according to an embodiment of the present invention. FIG. 3 demonstrates interactions between Bill Pay Provider 202, IIN 204 and Lockbox Service Provider 206. FIG. 3 provides details when lockbox rules may determine a rejected transaction at 252. At 310, data of rejected transactions may be sent to IIN 204. At 312, instructions may be sent to Centralized Lockbox Deposit Account 246 to revert funds back to a Bill Pay Deposit Account. At 314, rejected data may be sent from Lockbox Service Provider 206 to IIN 204. Centralized Lockbox Deposit Account 246 may return funds with associated reference data via 316 to Bill Pay Deposit Account 318. At 320, data may be received by IIN and distributed to an associated Bill Pay Provider. At 322, a Reject Database may log a specific remitter of the transaction to the specific Lockbox and then reject future transactions of the remitter to the specific Lockbox going forward. As shown by 322, a Reject Flag may be updated. Other flags may be applied to identify other conditions, status, etc. At 324, reject data may be sent to Bill Pay Providers 202 via Bill Pay Platform 218. At 326, rejected transactions received may be recycled back into Business as Usual (BAU) Check Print Files and follow BAU Legacy Model at Check Print Facility 238.

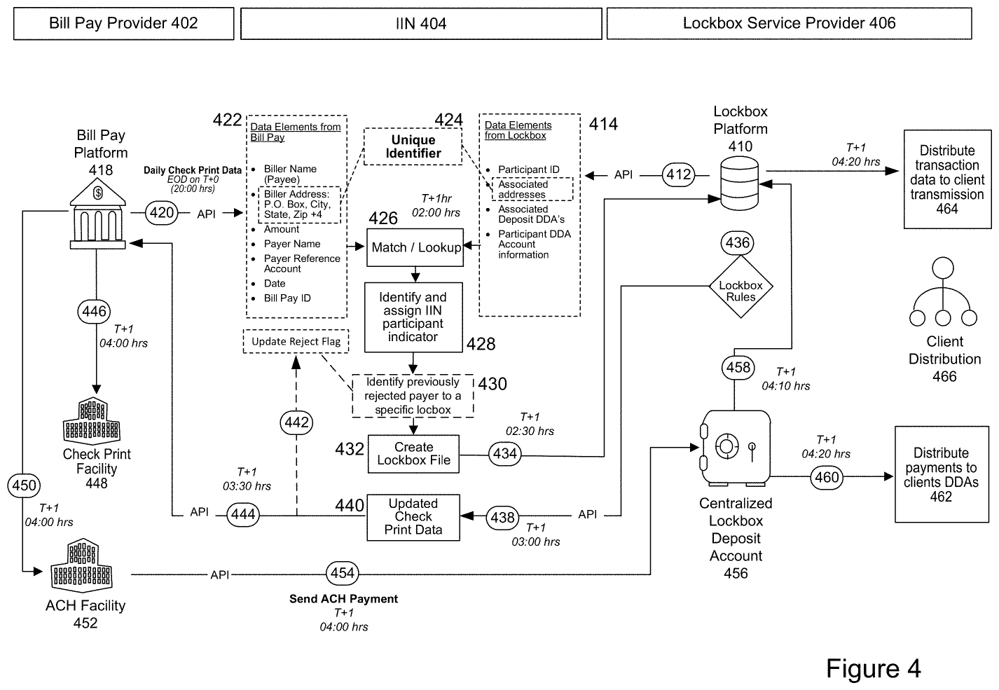

FIG. 4 is an exemplary flow illustrating an electronic exchange for bill pay transactions via IIN, according to an embodiment of the present invention. FIG. 4 may represent a variation of the exemplary flow illustrated in FIG. 2. FIG. 4 illustrates a digital bill pay lockbox platform via IIN. FIG. 4 demonstrates interactions between Bill Pay Provider 402, IIN 404 and Lockbox Service Provider 406. Lockbox Platform 410 may provide biller lockbox address and reference data via real time updates. Lockbox Platform may provide this information at 412 via API. Reference data elements may be represented at 414, which may include participant identifier, associated addresses, associated Deposit DDA's, participant DDA account information, etc.

Bill Pay Platform 418 may provide daily check print data at 420 via an API. Data Elements 422 may include biller name (e.g., payee), biller address, amount, payer name, payer reference account, date, bill pay identifier, etc.

IIN 404 may generate a unique identifier 424, which may be based on a data element, such as an associated address information, for example. At 426, IIN 204 may perform a match or lookup that compares Data Elements from Bill Pay 422 and Data Elements from Lockbox 414. IIN 404 may then identify and assign an IIN participant indicator at 428. At 430, a previously rejected payer to a specific lockbox may be identified. At 432, a lockbox file may be created. At 434, IIN participant lockbox data file may be sent to Lockbox Platform 410. At 436, lockbox rules may be applied. For example, the rules may identify rejected transactions and also provide reject reasons, such as “Stop/Go” file, unacceptable payee, client driven exceptions, etc. At 438, IIN participant may send accepted and/or rejected transactions. At 440, check print data may be updated. At 442, a reject flag may be updated. Other flags may be applied to identify other conditions, status, etc. At 444, an updated file may be sent to Bill Pay Platform 418. The updated file may include accepted IIN participant transactions with associated lockbox provide indicator; rejected IIN participant transactions; previously rejected payers for a lockbox and non IIN participant transactions. Other types of transactions may be included. At 446, Bill Pay Platform 418 may send updated file data, e.g., rejected IIN participant transactions; previously rejected payers for a lockbox and non IIN participant transactions, to Check Print Facility 448. At 450, Bill Pay Platform 418 may send updated file data, e.g., accepted IIN participant transactions with associated lockbox provide indicator, to ACH Facility 452. For example, ACH Facility 452 may create nightly (or other interval) ACH files to each Lockbox Provider. At 454, ACH payment may be sent from ACH Facility 452 to Centralized Lockbox Deposit Account 456. At 458, Centralized Lockbox Deposit Account 456 may notify of an ACH receipt to Lockbox Platform 410. As shown in FIG. 4, ACH is one illustrative example. Other forms of payment, including digital currency, may be applied. At 460, Payments may be distributed to clients DDAs (or other accounts) as shown by 462. Transaction data may be distributed via client transmission as shown by 464. Client distributions may be made at 466.

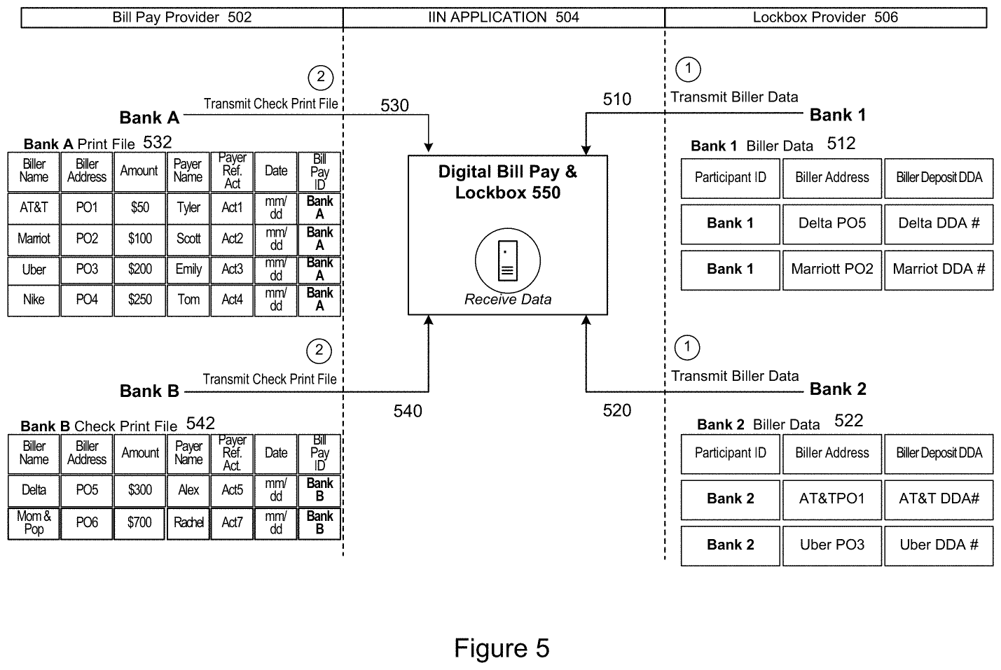

FIG. 5 is an exemplary system diagram, according to an embodiment of the present invention. FIG. 5 illustrates interactions between Bill Pay Provider 502, IIN Application 504 and Lockbox Provider 506. As shown in FIG. 5, Digital Bill Pay & Lockbox 550 may include nodes, e.g., Bill Pay Provider nodes and Lockbox Provider nodes. Bill Pay and Lockbox providers send data to Digital Lockbox Application, such as IIN application that executes on a platform or central system.

Lockbox Provider 506 may include Bank 1 and Bank 2. Bank 1 may transmit biller data to Digital Bill Pay & Lockbox 550 via 510. Digital Bill Pay & Lockbox 550 may include a user interface to receive data. Bank 1 Biller Data 512 may include Participant Identifier (ID), Biller Address, Biller Deposit DDA, etc. Address information may be represented by PO Box numbers, for example. Bank 2 may transmit biller data to Digital Bill Pay & Lockbox 550 via 520. Bank 2 Biller Data 522 may include Participant Identifier (ID), Biller Address, Biller Deposit DDA, etc.

Bill Pay Provider 502 may include Bank A and Bank B. Bank A may transmit a check print file to Digital Bill Pay & Lockbox 550 via 530. Bank A Print File 532 may include Biller Name, Biller Address, Amount, Payer Name, Payer Reference Account, Date and Bill Pay Identifier (ID), etc. Bank B may transmit check print file to Digital Bill Pay & Lockbox 550 via 540. Bank B Check Print File 542 may include Biller Name, Biller Address, Amount, Payer Name, Payer Reference Account, Date and Bill Pay Identifier (ID), etc.

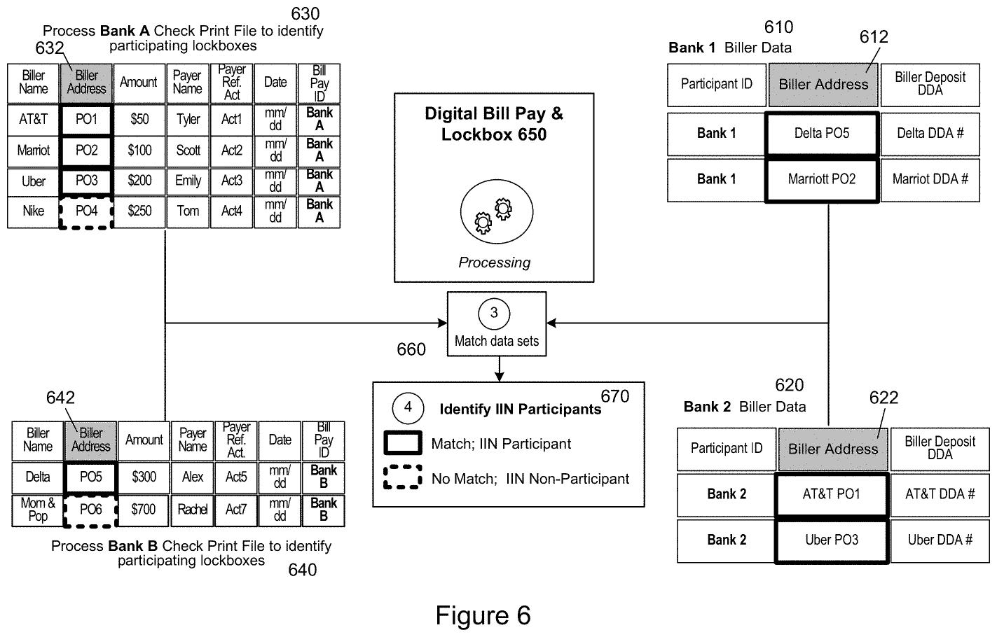

FIG. 6 is an exemplary system diagram, according to an embodiment of the present invention. An embodiment of the present invention may match Bill Pay and Lockbox Provider data sets to identify IIN participants. As shown in FIG. 6, data sets may be matched at 660. Bank 1 Biller data 610 and Bank 2 Biller data 620 may be compared with data from Bank A and Bank B.

Bank A check print file may be processed to identify participating lockboxes at 630. Bank B check print file may be processed to identify participating lockboxes at 640. At 660, a unique identifier may be used for matching as shown by 612 and 622 (from Biller Data) and 632 and 642 (from Check Print Files). Data sets may be matched to identify IIN participants at 670. Matched identifiers may be processed by comparing Biller Addresses, as shown by 632 and 642. In this example, matched participants may be identified as PO1, PO2, PO3 (at Bank A check print file) and PO5 (at Bank B check print file). Mismatched participants may be identified as PO4 (at Bank A check print file) and PO6 (at Bank B check print file).

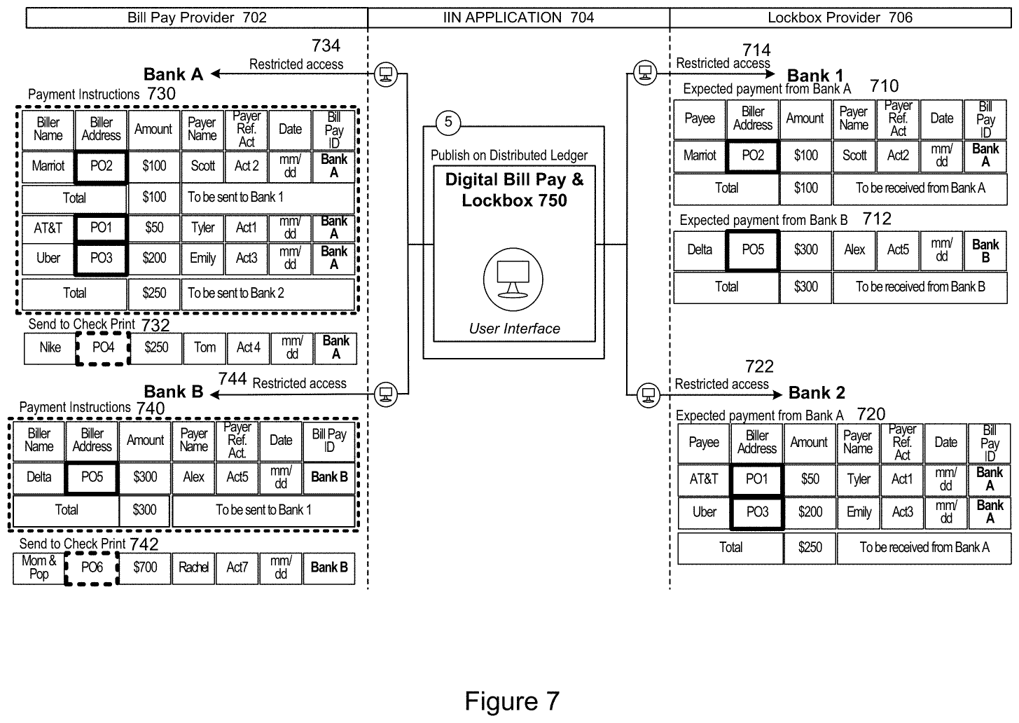

FIG. 7 is an exemplary system diagram, according to an embodiment of the present invention. IIN Application distributes data to Bill Pay and Lockbox Providers. FIG. 7 illustrates interactions between Bill Pay Provider 702, IIN Application 704 and Lockbox Provider 706. Digital Bill Pay & Lockbox 760 may publish data on a Distributed Ledger. For example, a single distributed ledger with built-in entitlements may be provided for restricted access.

Bank 1 may receive an expected payment from Bank A, as shown by 710. The payment file may include Payee, Biller Address, Amount, Payer Name, Payer Reference Account, Bill Pay Identifier (ID), etc. Bank 1 may also receive an expected payment from Bank B, as shown by 712. Restricted Access may be provided at 714.

Bank 2 may receive an expected payment from Bank A, as shown by 720. The payment file may include Payee, Biller Address, Amount, Payer Name, Payer Reference Account, Bill Pay Identifier (ID), etc. Restricted Access may be provided at 722.

Bank A may access payment instructions 730, which may include Biller Name, Biller Address, Amount, Payer Name, Payer Reference Account, Date, Bill Pay Identifier (ID), etc. Payment Instructions may be sent to multiple recipients, including Bank 1 and Bank 2. Bank A may also send to Check Print 732. Restricted Access may be provided at 734.

Bank B may access payment instructions 740, which may include Biller Name, Biller Address, Amount, Payer Name, Payer Reference Account, Date, Bill Pay Identifier (ID), etc. Payment Instructions may be sent to one or more recipients, including Bank 1. Bank B may also send to Check Print 742. Restricted Access may be provided at 744.

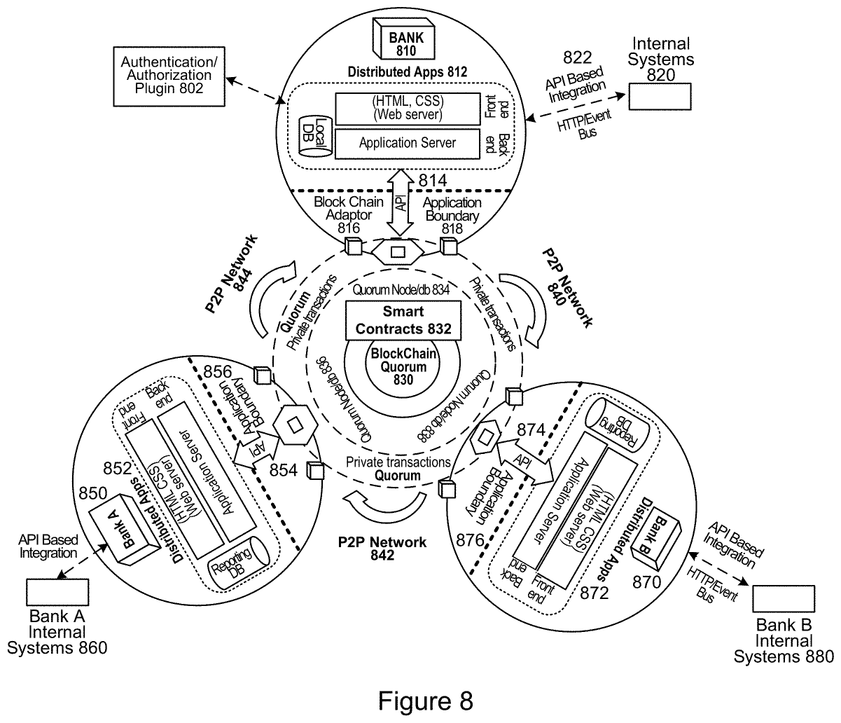

FIG. 8 is an exemplary system diagram, according to an embodiment of the present invention. IIN may be deployed as a Distributed Application with a layered approach for UI, Service, Orchestration, and Integration Layers.

As shown in FIG. 8, Bank 810 may support Distributed Applications 812, which may include Front End (e.g., Web Server), Back End (e.g., Application Server) and a Local Database. For example, Application Server may provide a service based approach for message parsing, logging, business logic and other services. Distributed Apps 812 may communicate with Authentication/Authorization Plugin 802. Distributed Apps 812 may also communicate with Internal Systems 820, via communication network 822 which may provide API based integration and support HTTP/Event Bus. An embodiment of the present invention may provide an adaptor-based approach for Integration with underlying BlockChain. Distributed Apps 812 may communicate with a Quorum Node/dB 834 via API 814. Bank 810 may further implement Block Chain Adaptor 816 and Application Boundary 818.

As shown in FIG. 8, each participant node may integrate with an underlying Blockchain. An embodiment of the present invention may provide various key features including configuration based permissioning; privacy via private contracts and transactions; RAFT based consensus for high performance (other consensus algorithms may be applied); and Smart Contracts.

BlockChain Quorum 830 may be Smart Contracts based, as shown by 832. Quorum Nodes/dB may communicate with each Bank or other participant. For example, Quorum Node/dB 834 may communicate with Bank 810; Quorum Node/dB 836 may communicate with Bank A 850; and Quorum Node/dB 838 may communicate with Bank B 870. Private transactions may be supported by P2P Networks, represented by 840, 842 and 844.

Bank A 850 may support Distributed Applications 852, which may include Front End (e.g., Web Server), Back End (e.g., Application Server) and a Reporting Database. For example, Application Server may provide a service based approach for message parsing, logging, business logic and other services. Bank A 850 may also communicate with Bank A Internal Systems 860, via an API based integration. Distributed Apps 852 may communicate with a Quorum Node/dB 836 via API 854. Bank A 850 may further implement Application Boundary 856.

Bank B 870 may support Distributed Applications 872, which may include Front End (e.g., Web Server), Back End (e.g., Application Server) and a Reporting Database. For example, Application Server may provide a service based approach for message parsing, logging, business logic and other services. Bank B 870 may also communicate with Bank B Internal Systems 880, via an API based integration and/or HTTP/Event Bus. Distributed Apps 872 may communicate with a Quorum Node/dB 838 via API 874. Bank B 870 may further implement Application Boundary 876.

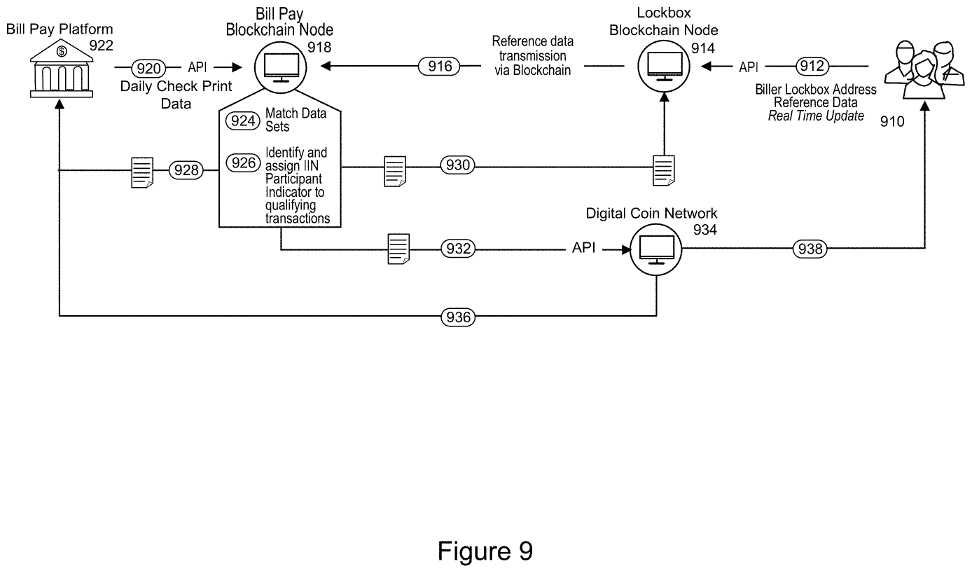

FIG. 9 is an exemplary flow illustrating an electronic exchange for bill pay transactions via IIN, according to an embodiment of the present invention.

At 912, lockbox data may be sent from Lockbox providers 910 to Lockbox Blockchain Node 914. Billers may include clients that have few rules and possibility of exceptions. Lockbox data may include addresses and reference data, which may be sent via real-time updates. At 916, reference data transmission may be sent via Blockchain to Bill Pay Blockchain Node 918.

Application functionality may be deployed on Bill Pay Blockchain Nodes and Lockbox Blockchain Nodes. Bill Pay Blockchain Nodes may include API to check print systems; UI to monitor status of transactions and other functionality. In addition, Bill Pay Blockchain Nodes may interact with other Lockbox nodes only (e.g., no interaction with other Bill Pay nodes); receive and store Lockbox reference data from Lockbox nodes; match Bill Pay and Lockbox reference data to identify eligible transactions; parse and transmit Bill Pay transactions to appropriate Lockbox Nodes; and receive enriched check print transactions from lockbox nodes indicating transactions that are rejected by Lockbox and initiate settlements.

Lockbox Blockchain Nodes may include API to remittance systems and rules engines; UI to monitor status of transactions and other functionality. In addition, Lockbox Blockchain Nodes may interact with other Bill Pay nodes only; send Lockbox reference data periodically or real-time; store own Lockbox reference data; ingest bill pay transactions from other bill pay nodes; transmit bill pay transactions to lockbox rules engine; ingest feedback from rules engine indicating rejected transactions; and transmit enriched check print transmission to appropriate bill pay nodes indicating transactions that are rejected.

At 920, Bill Pay Platform 922 may send check print data, which may occur daily or at other intervals, to Bill Pay Blockchain Node 918. For example, an additional channel may be implemented for check print transmission. As shown in FIG. 9, check print data may be sent to IIN app residing on a node via an API automated channel. Node 918 may execute an IIN application.

At 924, IIN app may match the two data sets to determine eligible transactions. At 926, IIN app may flag the IIN eligible transactions, as well as the transactions eligible for settlement via Digital Coin Network 934. At 928, IIN app may create an updated file. At 930, IIN app may parse eligible transactions and transmit the same to Lockbox Blockchain Node 914.

At 932, IIN app may send instructions for Issuance, Transfer and Redemption requests via a Digital Coin API. Digital Coin Network 934 may send the updated notification once the funds have settled to Bill Pay Platform 922, via 936, and Lockbox providers 910, via 938.

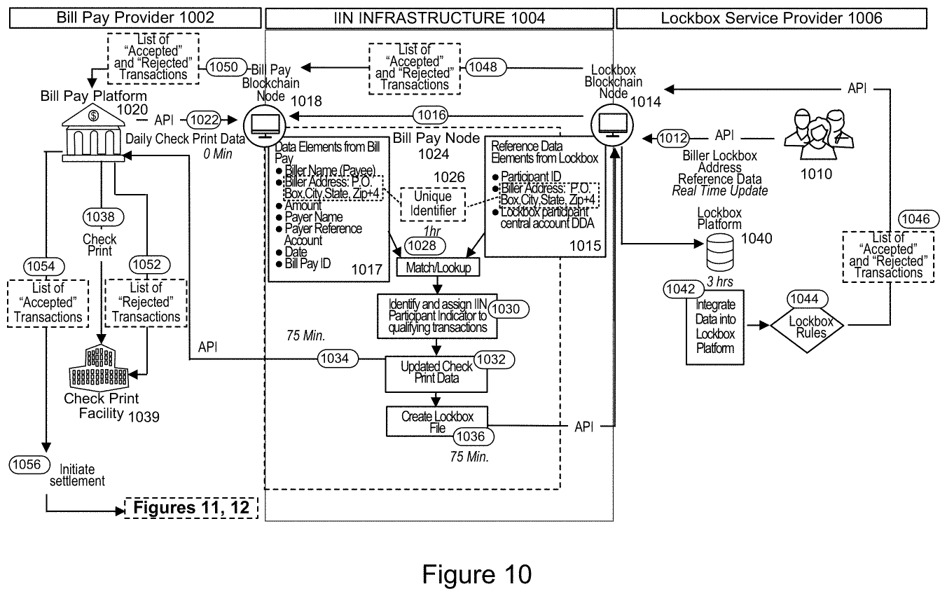

FIG. 10 is an exemplary flow illustrating an electronic exchange for bill pay transactions via IIN, according to an embodiment of the present invention. FIG. 10 demonstrates interactions between Bill Pay Provider 1002, IIN Infrastructure 1004 and Lockbox Service Provider 1006. Lockbox Providers 1010 may provide biller lockbox address and reference data via real time updates, via 1012. This information may be provided to a Lockbox Blockchain Node 1014 via API. Reference data elements may be represented at 1015, which may include participant identifier, associated addresses (e.g., biller address), lockbox participant central account, DDA, etc. At 1016, reference data may be transmitted via IIN network to Bill Pay Blockchain Node 1018.

Bill Pay Platform 1020 may provide daily check print data at 1022 via API. Data Elements 1017 may include biller name (e.g., payee), biller address, amount, payer name, payer reference account, date, bill pay identifier, etc.

Bill Pay Node 1024 may generate a unique identifier 1026, which may be based on a data element, such as an associated address information, for example. At 1028, Bill Pay Node 1024 may perform a match or lookup that compares data elements. Bill Pay Node 1024 may then identify and assign an IIN participant indicator to qualifying transactions at 1030. At 1032, check print data may be updated.

At 1034, data transmission to Bill Pay Platform 1020 may include data with flags that identify which transactions require check print and which transactions go through IIN with an indicator that associates a lockbox provider. At 1036, a lockbox file may be created. IIN App on Lockbox node may consolidated bill pay transaction data at Lockbox Blockchain Node 1014.

At 1038, Bill Pay Platform 1020 may send non-IIN transactions to check print, via business as usual legacy systems.

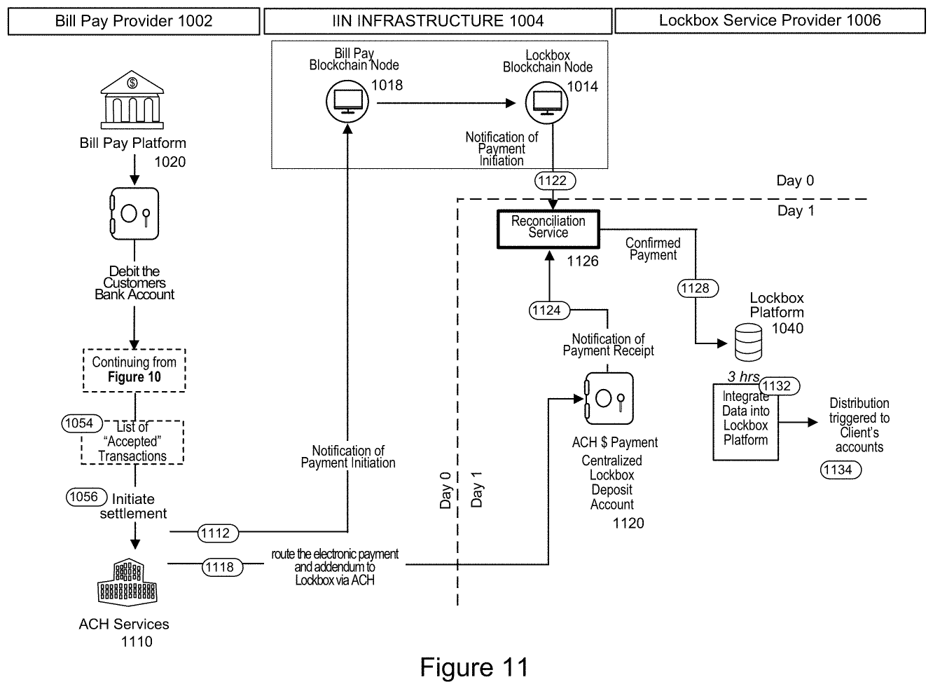

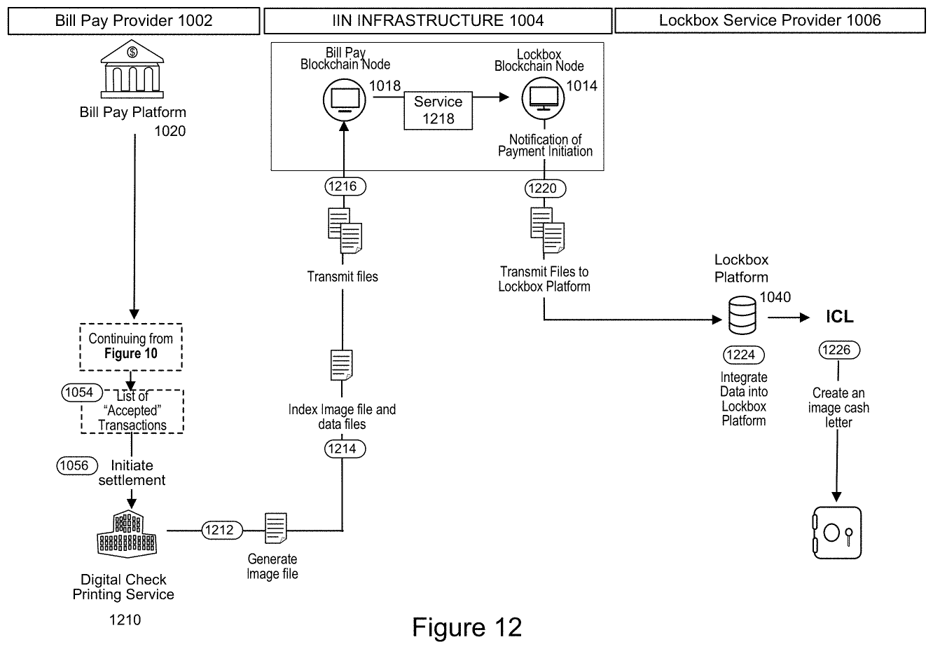

At 1042, Lockbox Blockchain Node 1014 may integrate data into Lockbox Platform 1040. Lockbox Rules may be applied at 1044 to determine accepted and rejected transactions. A list or other communication may be sent via 1046 to Lockbox Blockchain Node 1014, via API. At 1048, Lockbox Blockchain Node 1014 may send a list of accepted and rejected transactions to Bill Pay Blockchain Node 1018. At 1050, the list may be communicated to Bill Pay Platform 1020. At 1052, a list of rejected transactions may be sent to Check Print Facility 1039. At 1054, a list of accepted transactions may be sent to a settlement process at 1056. The settlement process is illustrated in further detail by FIGS. 11 and 12.

FIG. 11 is an exemplary flow illustrating a settlement flow, according to an embodiment of the present invention. The settlement flow of FIG. 11 illustrates a settlement flow for ACH services. As shown in FIG. 11, Bill Pay Platform 1020 may debit customers' bank accounts. For banks, this may happen at the same (or near same) time as the initiation of the bill pay transaction. At 1054, a list of accepted transactions may be sent to a settlement process at 1056.

At 1112, ACH Services 1110 may send a notification of payment initiation to Bill Pay Blockchain Node 1018, which communicates to Lockbox Blockchain Node 1014.

At 1118, ACH Services 1110 may route an electronic payment (e.g., CTX file) and addendum to Lockbox via ACH 1120. ACH 1120 may represent a centralized lockbox deposit account. At 1122, notification of payment initiation may be sent to Reconciliation Service 1126. At 1124, ACH 1120 may send a notification of payment receipt to Reconciliation Service 1126. At 1128, payment confirmation may be sent to Lockbox Platform 1040. At 1132, data may be integrated into Lockbox Platform 1040. Distribution may be triggered to client accounts at 1134.

FIG. 12 is an exemplary flow illustrating a settlement flow, according to an embodiment of the present invention. The settlement flow of FIG. 12 illustrates a settlement flow for digital checks. As shown in FIG. 12, Bill Pay Platform 1020 may debit customer's bank accounts. For banks, this may happen at the same (or near same) time as the initiation of the bill pay transaction. In addition, debiting a customer's account may or may not happen depending on a bank's model or if it's coming from a third party check originator. At 1054, a list of accepted transactions may be sent to a settlement process at 1056.

As shown in FIG. 12, Digital Check Printing Services 1210 may centrally print images (e.g., 6 or more) on a page than scan these images into an image file, at 1212. Other formats may be implemented. At 1214, image file and data files may be indexed to align each transaction to an image. At 1216, both files may be transmitted to Bill Pay Blockchain Node 1018 and Lockbox Blockchain Node 1014. Service 1218 may print check images received from a check originator and then scan those pages into a check image file. IIN may then distribute the data and image files to an identified lockbox provider for which that transaction belongs. Lockbox Blockchain Node 1014 may send a notification of payment initiation to Lockbox Platform 1040. Lockbox Blockchain Node 1014 may distribute assigned transactions and accompanying data and image. At 1220, both files may be transmitted to Lockbox Platform 1040.

At 1224, data may be integrated into Lockbox Platform 1040. Image Cash Letter (ICL) may create an image cash letter using check image files to send for clearing, at 1226.

FIGS. 2-4 and 10-12 illustrate exemplary flows, according to the various embodiments of the present invention. The flows include a representative timing in the form of T+X time, which is illustrative and exemplary and do not intend to limit the invention to a specific timing. The order of flows illustrated in FIGS. 2-4 and 10-12 is merely exemplary. While the processes of FIGS. 2-4 and 10-12 illustrate certain steps performed in a particular order, it should be understood that the embodiments of the present invention may be practiced by adding one or more steps to the processes, omitting steps within the processes and/or altering the order in which one or more steps are performed.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

Those skilled in the art will appreciate that the system diagrams discussed above are merely examples of an electronic exchange system and are not intended to be limiting. Other types and configurations of networks, servers, databases, mobile devices, and personal computing devices (e.g., desktop computers, tablet computers, mobile computing devices, smart phones, etc.) may be used with exemplary embodiments of the invention. Although the foregoing examples show the various embodiments of the invention in one physical configuration; it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. The components of the various embodiments may be arranged at any location or locations within a distributed network without affecting the operation of the respective system.

Data and information maintained by the servers and computing devices shown in FIG. 1 may be stored and cataloged in one or more databases, which may comprise or interface with a searchable database and/or a cloud database. The databases may comprise, include or interface to a relational database. Other databases, such as a query format database, a Standard Query Language (SQL) format database, a storage area network (SAN), or another similar data storage device, query format, platform or resource may be used. The databases may comprise a single database or a collection of databases. In some embodiments, the databases may comprise a file management system, program or application for storing and maintaining data and information used or generated by the various features and functions of the systems and methods described herein.

The communications networks in FIG. 1, may be comprised of, or may interface to any one or more of, for example, the Internet, an intranet, a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, an Asynchronous Transfer Mode (ATM) connection, a Fiber Distributed Data Interface (FDDI) connection, a Copper Distributed Data Interface (CDDI) connection, or an optical/DWDM network.

The communications networks in FIG. 1 may also comprise, include or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Bluetooth radio link, or an IEEE 802.11-based radio frequency link. The communications network may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, the communication network may comprise a satellite communications network, such as a direct broadcast communication system (DBS) having the requisite number of dishes, satellites and transmitter/receiver boxes, for example. The communications network may also comprise a telephone communications network, such as the Public Switched Telephone Network (PSTN). In another embodiment, the communication network may comprise a Personal Branch Exchange (PBX), which may further connect to the PSTN.

As described above, FIG. 1 includes a number of computing devices, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software. The modules described above may comprise software, firmware, hardware, or a combination of the foregoing.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. FIG. 1 may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although, the examples above have been described primarily as using a software application (“app”) downloaded onto the customer's mobile device, other embodiments of the invention can be implemented using similar technologies, such as transmission of data that is displayed using an existing web browser on the customer's mobile device.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system for implementing an electronic exchange via an interbank information network (IIN) architecture for bill pay transactions, the system comprising:
a first electronic input in communication with a bill pay platform associated with one or more bill payors;
a second electronic input in communication with a lockbox platform associated with one or more lockbox service providers; and
a computer processor, coupled to the first electronic input and the second electronic input, the computer processor executing an Interbank Information Network (IIN) application and is further configured to perform the steps of:
receiving, via the first electronic input, data elements from the bill pay platform;
receiving, via the second electronic input, reference data elements from the lockbox platform;
comparing, via the computer processor, the data elements and the reference data elements to identify one or more participants;
identifying, via the computer processor, a first set of transactions that require a check print and a second set of transactions that require processing through an Interbank Information Network (IIN);
transmitting, via the computer processor, a corresponding payment file for the second set of transactions to a centralized lockbox deposit account; and
transmitting, via the computer processor, a lockbox file to the one or more participants via the lockbox platform.

2. The system of claim 1, wherein the payment files comprise Automated Clearing House (ACH) files.

3. The system of claim 1, wherein the reference data elements comprise biller data.

4. The system of claim 1, wherein the data elements comprise a check print file from a bill pay provider.

5. The system of claim 1, wherein the comparing is based on a unique identifier shared by the reference data elements and the data elements.

6. The system of claim 1, wherein the comparing is based on biller address data.

7. The system of claim 1, wherein the one or more participants are participants of the IIN.

8. The system of claim 1, wherein transaction data is distributed based on one or more lockbox rules.

9. The system of claim 1, wherein the computer processor is further configured to perform the step of: publishing transaction data to a distributed ledger.

10. The system of claim 9, wherein the distributed ledger comprises built-in entitlements for restricted access.

11. A method for implementing an electronic exchange via an interbank information network (IIN) architecture for bill pay transactions, the method comprising the steps of:
receiving, via a first electronic input, data elements from a bill pay platform, wherein the first electronic input is in communication with the bill pay platform associated with one or more bill payors;
receiving, via a second electronic input, reference data elements from a lockbox platform, wherein the second electronic input is in communication with the lockbox platform associated with one or more lockbox service providers;
comparing, via a computer processor, the data elements and the reference data elements to identify one or more participants, wherein the computer processor is coupled to the first electronic input and the second electronic input and executes an Interbank Information Network (IIN) application;
identifying, via the computer processor, a first set of transactions that require a check print and a second set of transactions that require processing through an Interbank Information Network (IIN);
transmitting, via the computer processor, a corresponding payment file for the second set of transactions to a centralized lockbox deposit account; and
transmitting, via the computer processor, a lockbox file to the one or more participants via the lockbox platform.

12. The method of claim 11, wherein the payment files comprise Automated Clearing House (ACH) files.

13. The method of claim 11, wherein the reference data elements comprise biller data.

14. The method of claim 11, wherein the data elements comprise a check print file from a bill pay provider.

15. The method of claim 11, wherein the comparing is based on a unique identifier shared by the reference data elements and the data elements.

16. The method of claim 11, wherein the comparing is based on biller address data.

17. The method of claim 11, wherein the one or more participants are participants of the IIN.

18. The method of claim 11, wherein transaction data is distributed based on one or more lockbox rules.

19. The method of claim 11, further comprising the step of: publishing transaction data to a distributed ledger.

20. The method of claim 19, wherein the distributed ledger comprises built-in entitlements for restricted access.
